(19) United States
(12) Patent Application Publication
(10) Pub. No.: US 2011/0019735 A1
(43) Pub. Date: Jan. 27, 2011

(54) IMAGE ENCODING DEVICE AND IMAGE ENCODING METHOD

(76) Inventor: Kyohei KOYABU, Kanagawa (JP)

Correspondence Address: FROMMER LAWRENCE & HAUG, 745 FIFTH AVENUE- 10TH FL., NEW YORK, NY, 10151, US

(21) Appl. No.: 12/840,548

(22) Filed: Jul. 21, 2010

(30) Foreign Application Priority Data
Jul. 27, 2009 (JP) P2009-173910

(51) Int. Cl. H04N 7/26

(52) U.S. Cl. 375/240.03; 375/E07.139

(57) ABSTRACT

An image encoding device includes: a first encoding unit for encoding image data using multiple different quantizing matrices to calculate a generated code amount for each of the quantizing matrices; a code amount control unit for calculating an identification value that makes it identifiable from the generated code amount calculated at the first encoding unit whether or not there are many high-frequency components, selecting a first quantizing matrix for reducing high-frequency components at the time of this identification value distinguishing that the number of high-frequency components is greater than a threshold, and selecting a second quantizing matrix that reduces a smaller number of high-frequency components than the first quantizing matrix at the time of the identification value distinguishing that the number of high-frequency components is not greater than the threshold; and a second encoding unit for encoding the image data using the quantizing matrix selected at the code amount control unit.

### BACKGROUND OF THE INVENTION

1. Field of the Invention

The present invention relates to an image encoding device, and an image encoding method, and more specifically, it enables encoding of an image to be performed by reducing deterioration in image quality.

2. Description of the Related Art

Hitherto, with an image encoding method such as MPEG2 (Moving Picture Experts Group 2) or the like, it is a great problem to maintain subjective image quality to ideally distribute a code amount.

For example, an ideal code amount distribution of a still image is a state in which distortion is uniformly encoded (with a fixed quantized scale). When reaching a code amount whereby this distortion becomes great, subjective image quality can be enhanced by biasing the distortion toward a high-frequency component or complicated portion.

Now, for example, with International Publication WO96/28937, an image signal encoding method has been disclosed wherein the image quality of a decoded image can be improved by employing code amount control according to a feed forward method to enable control adapted to the local property of an image quality signal. The feed forward method is for determining a suitable quantizing scale in a range where a generated code amount does not exceed a target generated code amount by calculating a code amount to be generated in increments of equal lengthening regarding a plurality of quantizing scales.

On the other hand, with code amount control such as TM5 proposed as a test model with MPEG2, or the like, code amount control is performed by performing feedback control using relationship between the remaining amount of a virtual buffer, a quantization index at the time of previous encoding, and a generated code amount.

### SUMMARY OF THE INVENTION

Incidentally, with encoding of image data, a generated code amount can be reduced by performing encoding using a quantizing matrix for reducing high-frequency components. Accordingly, when decoding encoded data obtained by encoding the image data, an image from which the high-frequency components have been eliminated is obtained. Also, in the event of encoding a decoded image again, the quantizing parameter is apt to have a low value since the high-frequency components were reduced. Here, in the event of encoding a decoded image again, when encoding is performed using a quantizing matrix for reducing high-frequency components again, high-frequency components are eliminated in a wide range, so deterioration in image quality comes to be conspicuous.

It has been found to be desirable to provide an image encoding device and an image encoding method whereby deterioration in image quality can be reduced even when repeating encoding/decoding processing.

An embodiment of the present invention is an image encoding device including: a first encoding unit configured to perform encoding of image data using a plurality of different quantizing matrices to calculate a generated code amount for each of the quantizing matrices; a code amount control unit configured to calculate an identification value that makes it identifiable from the generated code amount calculated at the first encoding unit whether or not there are many high-frequency components, and to select a first quantizing matrix for reducing high-frequency components at the time of this identification value distinguishing that the number of high-frequency components is greater than a threshold, and to select a second quantizing matrix that reduces a smaller number of high-frequency components than the first quantizing matrix at the time of the identification value distinguishing that the number of high-frequency components is not greater than the threshold and small; and a second encoding unit configured to perform encoding of the image data using the quantizing matrix selected at the code amount control unit.

According the above configuration, with a third encoding unit, encoding of image data is performed using a fixed quantizing matrix and a fixed quantizing parameter, thereby calculating a generated code amount. With the first encoding unit, encoding of image data is performed using multiple different matrices and multiple different quantizing parameters including the quantizing matrix used at the third encoding unit, thereby calculating a generated code amount for each of the quantizing matrices and the quantizing parameters.

With the code amount control unit, an identification value that makes it identifiable from the generated code amount calculated at the first encoding unit whether or not there are many high-frequency components is calculated, and when this identification value distinguishes that the number of high-frequency components is greater than a threshold, a first quantizing matrix for reducing high-frequency components is selected from the multiple quantizing matrices used at the first encoding unit. Also, when the identification value distinguishes that the number of high-frequency components is not greater than the threshold and small, a second quantizing matrix that reduces a smaller number of high-frequency components than the first quantizing matrix is selected from the multiple quantizing matrices used at the first encoding unit. Also, when the generated code amount calculated at the third encoding unit is equal to or greater than an upper limit value, a third quantizing matrix for reducing a greater number of high-frequency components than the first quantizing matrix is selected.

Further, with the code amount control unit, prediction of a generated code amount at the time of using a quantizing parameter for realizing a target generated code amount, and a generated code amount at the time of using this quantizing parameter is performed based on the generated code amount calculated at the third encoding unit, this predicted generated code amount is corrected according to the generated code amount calculated at the first encoding unit, and a quantizing parameter is determined so that the generated code amount after correction realizes the target generated code amount. Here, when the selected quantizing matrix differs from the quantizing matrix used at the third encoding unit, a correction coefficient is calculated from the generated code amount calculated at the first encoding unit. For example, with a coefficient indicating the percentage of a generated code amount at the time of using the selected quantizing matrix as to a generated code amount at the time of using the fixed quantizing matrix used at the third encoding unit as a correction coefficient, the predicted generated code amount is corrected using this correction coefficient.

With the second encoding unit, encoding of image data is performed using the quantizing matrix and quantizing parameter from the code amount control unit.

Also, selection of a quantizing matrix for each picture within a GOP (Group of Picture) is performed, and when the quantizing matrices differ within the GOP, a quantizing matrix used by pictures of which the number is the most numerous is searched, and reselection of a quantizing matrix is performed by changing selection conditions so that this most frequent quantizing matrix is readily selected.

Another embodiment of the present invention is an image encoding method including the steps of: first encoding, performed by a first encoding unit, of image data using a plurality of different quantizing matrices to calculate a generated code amount for each of the quantizing matrices; calculating, with a code amount control unit, of an identification value that makes it identifiable from the generated code amount calculated at the first encoding unit whether or not there are many high-frequency components, selecting a first quantizing matrix for reducing high-frequency components at the time of this identification value distinguishing that the number of high-frequency components is greater than a threshold, and selecting a second quantizing matrix that reduces a smaller number of high-frequency components than the first quantizing matrix at the time of the identification value distinguishing that the number of high-frequency components is not greater than the threshold and small; and second encoding, performed by a second encoding unit, of the image data using the quantizing matrix selected at the code amount control unit.

According to the above configuration, encoding of image data is performed using multiple different quantizing matrices, and a generated code amount is calculated for each of the quantizing matrices. Also, an identification value that makes it identifiable from the calculated generated code amount whether or not there are many high-frequency components is calculated, and when this identification value distinguishes that the number of high-frequency components is greater than a threshold, a first quantizing matrix for reducing high-frequency components is selected, and when the identification value distinguishes that the number of high-frequency components is not greater than the threshold and small, a second quantizing matrix that reduces a smaller number of high-frequency components than the first quantizing matrix is selected. Further, encoding of image data is performed using the selected quantizing matrix. Therefore, in the event that high-frequency components have been reduced, encoding of image data is performed using a quantizing matrix for reducing a smaller number of high-frequency components, and accordingly, deterioration in image quality can be reduced even when repeating encoding/decoding processing.

### BRIEF DESCRIPTION OF THE DRAWINGS

FIG. 1 is a diagram illustrating the configuration of an image encoding device;

FIGS. 2A through 2C are diagrams illustrating quantizing matrices;

FIG. 3 is a flowchart illustrating the operation of the image encoding device;

FIG. 4 is a flowchart illustrating basic quantizing parameter determining processing;

FIG. 5 is a diagram (part 1) for describing processing for calculating a quantizing parameter and a generated code amount;

FIG. 6 is a diagram (part 2) for describing the processing for calculating a quantizing parameter and a generated code amount;

FIG. 7 is a flowchart illustrating processing for calculating 1 GOP worth of generated code amount;

FIG. 8 is a flowchart illustrating I picture generated code amount calculation processing;

FIG. 9 is a flowchart illustrating quantizing matrix selecting operation;

FIG. 10 is a flowchart illustrating quantizing matrix switching restriction processing;

FIG. 11 is a flowchart illustrating second generated code detecting processing;

FIG. 12 is a flowchart illustrating the operation of high-frequency component cost calculation;

FIG. 13 is a diagram illustrating the processing results of intra pre-encoding processing;

FIG. 14 is a flowchart illustrating second correction coefficient calculating operation; and

FIG. 15 is a flowchart illustrating non-I picture generated code amount calculation processing.

### DESCRIPTION OF THE PREFERRED EMBODIMENTS

An embodiment for implementing the present invention will be described below. With the present invention, encoding of image data is performed using multiple different quantizing matrices, and a generated code amount is calculated for each of the quantizing matrices. Also, an identification value that makes it identifiable from the calculated generated code amount whether or not there are many high-frequency components is calculated, and when this identification value distinguishes that the number of high-frequency components is greater than a threshold, a first quantizing matrix for reducing high-frequency components is selected, and when the identification value distinguishes that the number of high-frequency components is not greater than the threshold and small, a second quantizing matrix that reduces a smaller number of high-frequency components than the first quantizing matrix is selected. Encoding of image data is performed using thus selected quantizing matrix, and accordingly, deterioration in image quality is reduced. Note that description will be made in accordance with the following sequence.

### 1. Configuration of Image Encoding Device

### 2. Operation of Image Encoding Device

### 1. Configuration of Image Encoding Device

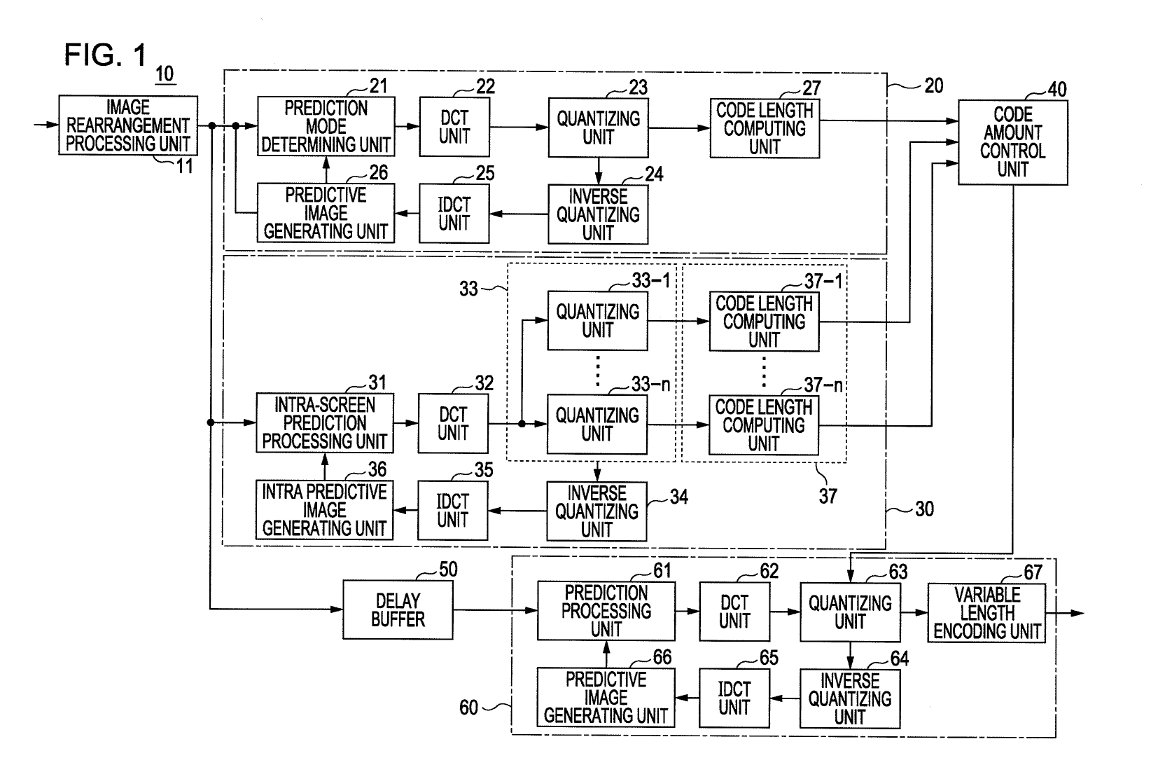

FIG. 1 illustrates the configuration of an image encoding device according to an embodiment of the present invention. An image encoding device 10 includes an image rearrangement processing unit 11, a pre-encoding unit 20, an intra pre-encoding unit 30, a code amount control unit 40, a delay buffer 50, and a main encoding unit 60.

The pre-encoding unit 20 includes a prediction mode determining unit 21, a DCT (Discrete Cosine Transform) unit 22, a quantizing unit 23, an inverse quantizing unit 24, an IDCT (Inverse Discrete Cosine Transform) unit 25, a predictive image generating unit 26, and a code length computing unit 27.

The intra pre-encoding unit 30 includes an intra-screen prediction processing unit 31, a DCT unit 32, a quantizing unit 33, an inverse quantizing unit 34, an IDCT unit 35, an intra predictive image generating unit 36, and a code length computing unit 37. Also, the quantizing unit 33 is configured of multiple stages of quantizing units 33-1 through 33-n, and the code length computing unit 37 is configured of multiple stages of code length computing units 37-1 through 37-n.

The main encoding unit 60 includes a prediction processing unit 61, a DCT unit 62, a quantizing unit 63, an inverse quantizing unit 64, an IDCT unit 65, a predictive image generating unit 66, and a variable length encoding unit 67.

With such a configuration, the image rearrangement processing unit 11 rearranges the image data of an input image in the sequence of pictures from the display sequence to the encoding sequence in accordance with, for example, a GOP (Group of Picture) configuration. Subsequently, the image rearrangement processing unit 11 outputs the image data rearranged in the encoding sequence to the pre-encoding unit 20, the intra pre-encoding unit 30, and the delay buffer 50.

The pre-encoding unit 20 serving as a third encoding unit performs calculation of a generated code amount by quantizing the image data using a fixed quantizing parameter, and outputs the calculated generated code amount to the code amount control unit 40. The prediction mode determining unit 21 of the pre-encoding unit 20 determines a prediction mode for each macro block using the image data of the input image, and the predictive image data generated at the later-described predictive image generating unit 26. Also, the prediction mode determining unit 21 uses the predictive image data of the determined prediction mode to output difference image data indicating error as to the image data of the input image to the DCT unit 22.

The DCT unit 22 performs discrete cosine transform as to the difference image data to generate a DCT coefficient, and outputs this to the quantizing unit 23.

The quantizing unit 23 performs quantization of the DCT coefficient using a fixed quantizing parameter QP(p), and outputs the generated quantized data to the inverse quantizing unit 24 and the code length computing unit 27.

The inverse quantizing unit 24 performs inverse quantization as to the quantized data to generate a DCT coefficient, and outputs this to the IDCT unit 25.

The IDCT unit 25 performs inverse discrete cosine transform of the DCT coefficient supplied from the inverse quantizing unit 24 to generate difference image data, and outputs this to the predictive image generating unit 26.

The predictive image generating unit 26 uses the difference image data to generate the image data of a local decoded image. Also, the predictive image generating unit 26 uses the image data of the input image to perform motion estimation between the current frame and the next temporally adjacent frame in increments of macro blocks. Further, the predictive image generating unit 26 performs motion compensation of the local decoded image based on the motion estimation results to generate predictive image data from the image data of the local decoded image, and outputs this to the prediction mode determining unit 21.

The code length computing unit 27 performs encoding as to the quantized data using either the Context-Adaptive Variable Length Coding (CAVLC) method or the Context-Adaptive Binary Arithmetic Coding (CABAC) method, calculates a generated code amount for each macro block, and outputs this to the code amount control unit 40.

The CAVLC method is a method simpler than the CABAC method, and the CABAC method is a method whereby data amount can be reduced as compared to the CAVLC method. Now, description will be made regarding a case where the variable length coding method is employed at the pre-encoding unit 20 for simplifying the processing, and the arithmetic coding method is employed at the main encoding unit 60 for reducing data amount. With the variable length coding, the information of a certain region is effectively encoded, and with the arithmetic coding, a region can effectively be encoded without being identified. Accordingly, great error may be caused when predicting a code amount of the arithmetic coding from the variable length coding. However, the CAVLC can effectively encode a region without identifying the region well as compared to common variable length coding by adaptively changing context. Thus, the error is reduced, and a generated code amount at the time of employing the CABAC method can be estimated by encoding according to the CAVLC method. Accordingly, a generated code amount at the main encoding unit 60 employing the CABAC method can also be estimated by employing the CAVLC method at the code length computing unit 27. Note that the code length computing unit 27 can also suppress the circuit scale by employing the CAVLC method.

The intra pre-encoding unit 30 serving as a first encoding unit performs quantization using multiple different quantizing parameters with all of the image data as I pictures, and calculates a generated code amount for each of the quantizing parameters to output this to the code amount control unit 40. The intra-screen prediction processing unit 31 of the intra pre-encoding unit 30 generates difference image data indicating error between the image data of the input image, and the predictive image data generated at the intra predictive image generating unit 36 to output this to the DCT unit 32.

The DCT unit 32 performs discrete cosine transform as to the difference image data to generate a DCT coefficient, and outputs this to the quantizing unit 33.

The quantizing unit 33 is configured of multiple stages, e.g., nine stages of quantizing units 33-1 through 33-9. The quantizing units 33-1 through 33-9 perform quantization in accordance with nine conditions by combining three different quantizing parameters QP(i0), QP(i1), and QP(i2), and three different quantizing matrices QMF, QMN, and QMS. The quantizing units 33-1 through 33-9 outputs the quantized data obtained by performing quantization of the DCT coefficient to the code length computing unit 37. Also, the quantizing unit 33 selects one of the quantized data generated at the quantizing units 33-1 through 33-9, and outputs this to the inverse quantizing unit 34.

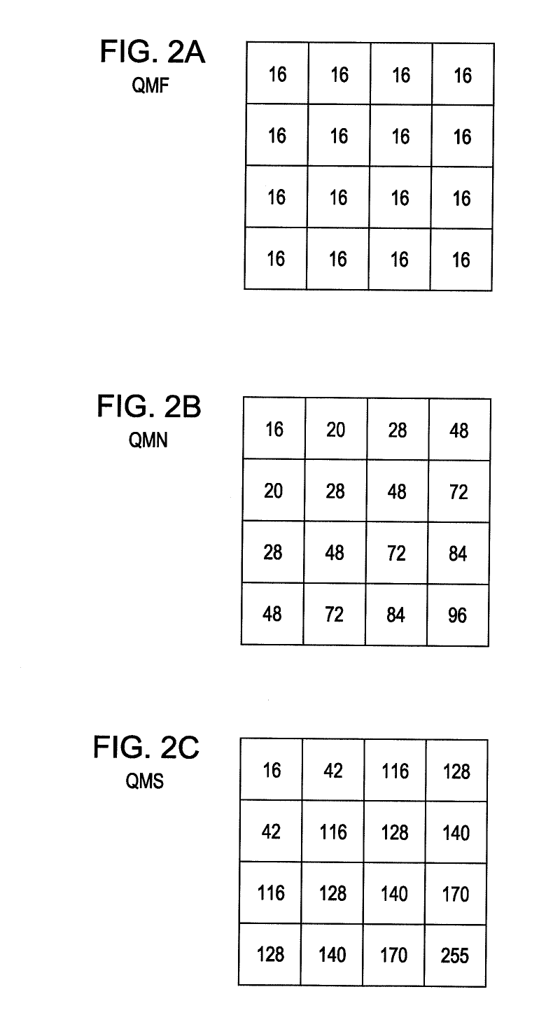

FIGS. 2A through 2C exemplify the quantizing matrices QMF, QMN, and QMS. FIG. 2A illustrates the quantizing matrix QMF. With the quantizing matrix QMF, all matrix values are equal values. That is to say, the quantizing matrix QMF is a quantizing matrix having a flat property. FIG. 2B illustrates the quantizing matrix QMN. With the quantizing matrix QMN, the matrix value of a high-frequency component is greater than the matrix value of a low-frequency component. That is to say, the quantizing matrix QMN is a quantizing matrix having a common property wherein reduction of high-frequency components is performed. FIG. 2C illustrates the quantizing matrix QMS. With the quantizing matrix QMS, the matrix value of a high-frequency component is a further greater value as compared to the quantizing matrix QMN. That is to say, the quantizing matrix QMS is a quantizing matrix having a property wherein reduction of high-frequency components is further increased as compared to the quantizing matrix QMN.

The inverse quantizing unit 34 performs inverse quantization as to the quantized data supplied from the quantizing unit 33 to generate DCT coefficient data, and outputs this to the IDCT unit 35.

The IDCT unit 35 performs inverse discrete cosine transform of the DCT coefficient data supplied from the inverse quantizing unit 34 to generate difference image data, and outputs this to the intra predictive image generating unit 36.

The intra predictive image generating unit 36 uses the difference image data to generate the image data of the local decoded image. Also, the intra predictive image generating unit 36 outputs the image data of the local decoded image to the intra-screen prediction processing unit 31 as predictive image data.

The code length computing unit 37 is configured of multiple stages, e.g., nine stages of code length computing units 37-1 through 37-9 corresponding to the quantizing unit 33. The code length computing units 37-1 through 37-9 perform encoding using the same method as with the code length computing unit 27 of the pre-encoding unit 20 to calculate a generated code amount for each macro block, and output this to the code amount control unit 40.

The code amount control unit 40 calculates an identification value that makes it identifiable from the calculated generated code amount whether or not there are many high-frequency components, and when this identification value distinguishes that the number of high-frequency components is greater than a threshold, selects a quantizing matrix for reducing high-frequency components, and when the identification value distinguishes that the number of high-frequency components is smaller than the threshold, selects a quantizing matrix that reduces a smaller number of high-frequency components. Also, the code amount control unit 40 determines a target generated code amount to be assigned to 1 GOP from relationship between a bit rate and a GOP configuration.

The code amount control unit 40 predicts a quantizing parameter for realizing a target generated code amount, and a generated code amount when employing this quantizing parameter based on 1 GOP worth of the generated code amount calculated at the pre-encoding unit 20. That is to say, the code amount control unit 40 predicts a quantizing parameter wherein the generated code amount of 1 GOP is equal to or smaller than the target generated code amount and most closely approximating the target generated code amount, and a generated code amount when employing this quantizing parameter. Also, the code amount control unit 40 corrects the predicted generated coded amount in accordance with the generated code amount calculated at the intra pre-encoding unit 30. Further, the code amount control unit 40 determines a quantizing parameter for realizing the target generated code amount from the generated code amount after correction. Here, in the event that a quantizing matrix different from the quantizing matrix used at the pre-encoding unit 20 has been selected, the code amount control unit 40 calculates a correction coefficient. The code amount control unit 40 selects, for example, from the generated code amount calculated at the intra pre-encoding unit 30, a generated code amount BT at the time of using the quantizing matrix used at the pre-encoding unit 20, and a generated code amount at the time of using the selected quantizing matrix. The code amount control unit 40 calculates a correction coefficient from the selected two generated code amounts. Note that, with the following description, a quantizing parameter for realizing the target generated code amount will be referred to as a basic quantizing parameter.

The delay buffer 50 delays the image data of the input image by the time used for processing for determining the basic quantizing parameter at the code amount control unit 40, and outputs the delayed image data to the main encoding unit 60.

The main encoding unit 60 serving as a second encoding unit performs quantization of the image data using the basic quantizing parameter and quantizing matrix determined at the code amount control unit 40. The prediction processing unit 61 of the main encoding unit 60 selects the image data of the input image delayed at the delay buffer 50, and predictive image data according to the picture type determined by the prediction mode determining unit 21 of the pre-encoding unit 20. Also, the prediction processing unit 61 generates a difference image indicating error between the selected predictive image data, and the image data of the input image, and outputs this to the DCT unit 62.

The DCT unit 62 performs discrete cosine transform as to the difference image to generate a DCT coefficient, and outputs this to the quantizing unit 63.

The quantizing unit 63 uses the quantization parameter and quantizing matrix determined at the code amount control unit 40 to perform quantization of the DCT coefficient, and outputs the quantized data to the inverse quantizing unit 64 and the variable length encoding unit 67.

The inverse quantizing unit 64 performs inverse quantization as to the quantized data to generate a DCT coefficient, and outputs this to the IDCT unit 65.

The IDCT unit 65 performs inverse discrete cosine transform of the DCT coefficient supplied from the inverse quantizing unit 64 to generate difference image data, and outputs this to the predictive image generating unit 66.

The predictive image generating unit 66 uses the difference image data to generate the image data of a local decoded image. Also, the predictive image generating unit 66 uses the image data from the delay buffer 50 to perform motion estimation between the current frame and the next temporally adjacent frame in increments of macro blocks. Further, the predictive image generating unit 66 performs motion compensation of the local decoded image based on the motion estimation results to generate a predictive image, and outputs this to the prediction processing unit 61.

The variable length encoding unit 67 performs encoding as to the quantized data by the CAVLC method or CABAC method to generate encoded streams, and outputs these. The variable length encoding unit 67 performs encoding of the quantized data using the CABAC method, for example, so as to reduce the data amount, to generate encoded streams.

### 2. Operation of Image Encoding Device

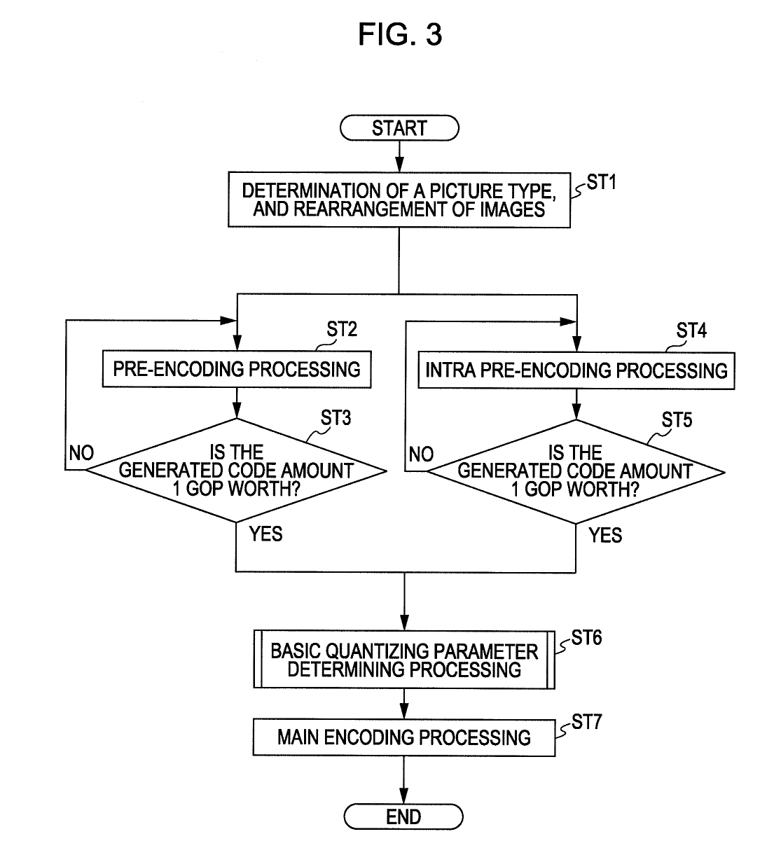

Next, the operation of the image encoding device will be described. FIG. 3 is a flowchart illustrating the operation of the image encoding device.

In step ST1, the image encoding device 10 performs determination of a picture type, and image rearrangement. The image encoding device 10 determines a picture type as to the input image, for example, in accordance with a GOP (Group of Picture) configuration. Also, the image encoding device 10 rearranges the image data of the input image at the image rearrangement processing unit 11 from the display sequence to the encoding sequence, and proceeds to step ST2.

In step ST2, the image encoding device 10 performs pre-encoding processing. The image encoding device 10 encodes the image data of the input image at the pre-encoding unit 20 using the determined picture type to calculate a generated code amount, and proceeds to step ST3.

In step ST3, the image encoding device 10 distinguishes whether or not the generated code amount has reached 1 GOP worth. In the event that the generated code amount calculated at the pre-encoding unit 20 has reached 1 GOP worth, the image encoding device 10 proceeds to step ST6, and in the event that the generated code amount has not reached 1 GOP worth, returns to step ST2.

In step ST4, the image encoding device 10 performs intra pre-encoding processing. The image encoding device 10 encodes the image data of the input image at the intra pre-encoding unit 30 as I picture to calculate a generated code amount, and proceeds to step ST5. Also, the image encoding device 10 performs encoding in parallel using multiple quantizing parameters and multiple quantizing matrices in the intra pre-encoding processing to calculate a generated code amount.

In step ST5, the image encoding device 10 distinguishes whether or not the generated code amount has reached 1 GOP worth. In the event that the generated code amount calculated at the intra pre-encoding unit 30 has reached 1 GOP worth, the image encoding device 10 proceeds to step ST6. Also, in the event that the generated code amount has not reached 1 GOP worth, the image encoding device 10 returns to step ST4.

In step ST6, the image encoding device 10 performs basic quantizing parameter determining processing and quantizing matrix selecting processing to be used in main encoding processing. The image encoding device 10 determines a basic quantizing parameter and quantizing matrix to be used for the main encoding processing at the code amount control unit 40 from the generated code amount obtained by performing the pre-encoding processing, and the generated code amount obtained by performing the intra pre-encoding processing.

In step ST7, the image encoding device 10 performs the main encoding processing. The image encoding device 10 uses the basic quantizing parameter and quantizing matrix determined in step ST6 to encode the image data of the input image at the main encoding unit 60.

Next, the basic quantizing parameter determining processing to be used for the main encoding processing will be described. With the basic quantizing parameter determining processing, a quantizing parameter for realizing the target generated code amount, and a generated code amount at the time of employing this quantizing parameter, are predicted based on the generated code amount calculated at the pre-encoding unit 20. Also, this predicted generated code amount is corrected according to the generated code amount calculated at the intra pre-encoding unit 30. When the target generated code amount is not realized by 1 GOP worth of the corrected generated code amount, prediction of a generated code amount, and correction thereof are preformed by changing the parameter value of the predicted quantizing parameter. When the target generated code amount is realized by 1 GOP worth of the corrected generated code amount, the quantizing parameter at this time is taken as a basic quantizing parameter.

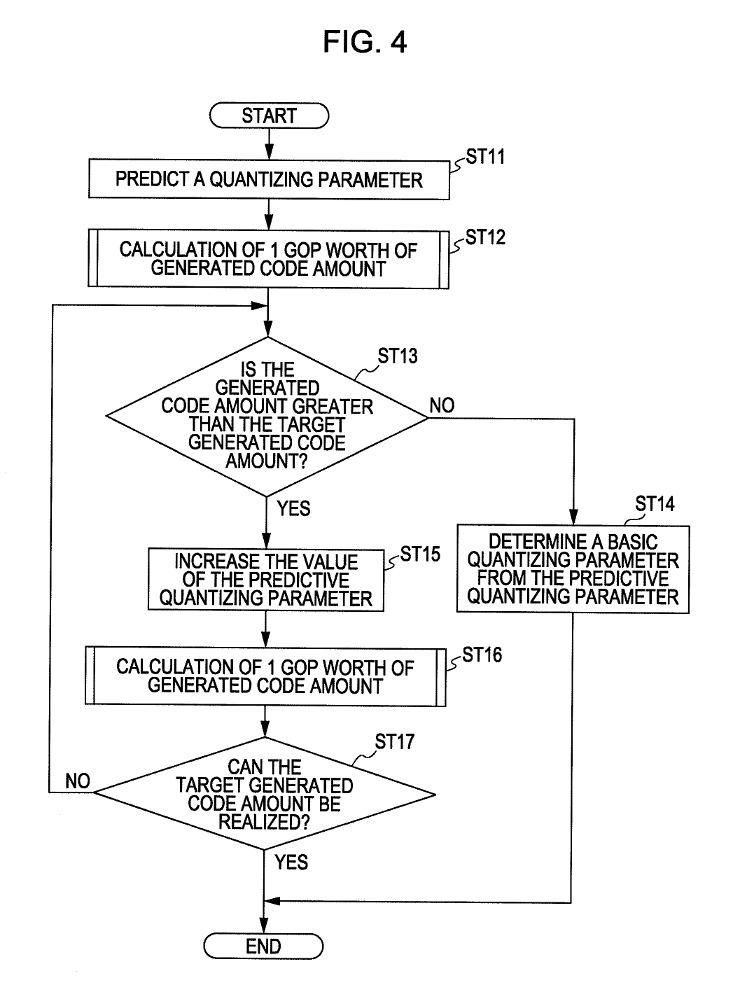

FIG. 4 exemplifies a flowchart illustrating the basic quantizing parameter determining processing to be used for the main encoding processing. In step ST11, the code amount control unit 40 performs prediction of a quantizing parameter. The code amount control unit 40 predicts a quantizing parameter for realizing the target generated code amount based on the generated code amount calculated at the pre-encoding unit 20, and proceeds to step ST12.

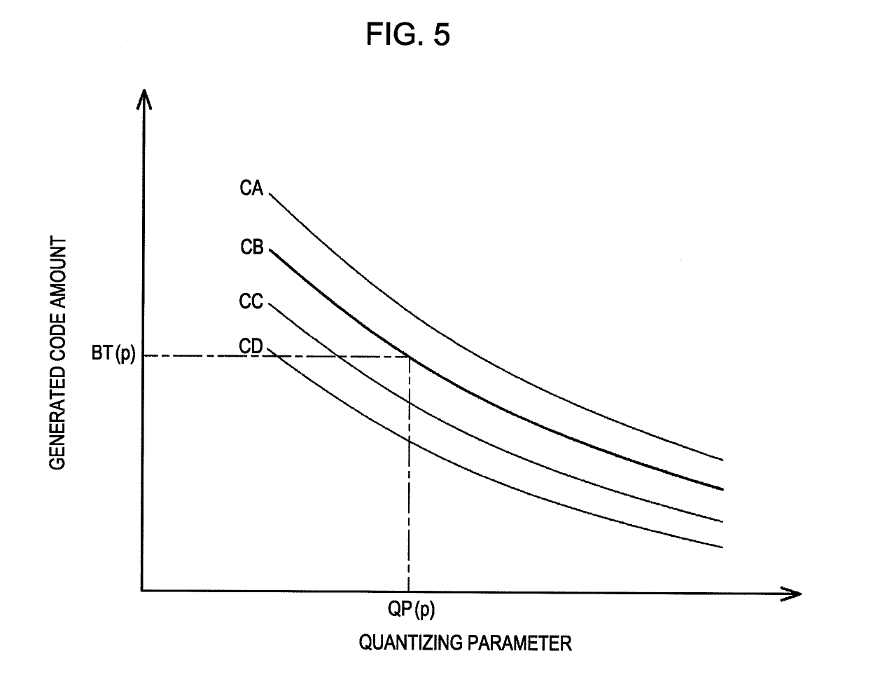

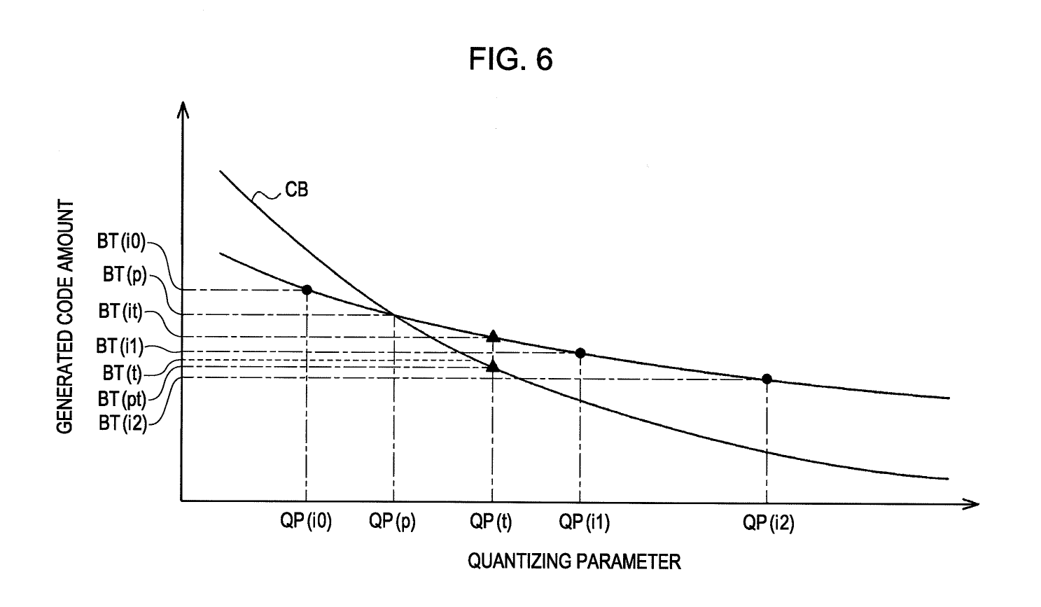

FIGS. 5 and 6 are diagrams for describing processing for calculating a quantizing parameter, and a generated code amount. The code amount control unit 40 classifies the macro blocks into groups using a fixed quantizing parameter QP(p) according to a generated code amount BT(p) at the time of performing encoding at the pre-encoding unit 20. Also, such as illustrated in FIG. 5, the predictive curve of the corresponding group, e.g., a predictive curve CB is selected from multiple predictive curves indicating relationship a quantizing parameter and a generated code amount provided beforehand for each group. Further, such as illustrated in FIG. 6, a quantizing parameter of which the generated code amount is equal to or smaller than the target generated code amount BT(t) and most closely approximated thereto is predicted using the selected predictive curve CB.

In step ST12, the code amount control unit 40 calculates 1 GOP worth of generated code amount. The code amount control unit 40 corrects the generated code amount predicted in step ST11 according to the generated code amount calculated at the intra pre-encoding unit 30, and calculates 1 GOP worth of the corrected generated code amount, and proceeds to step ST13.

In step ST13, the code amount control unit 40 distinguishes whether or not 1 GOP worth of generated code amount is greater than the target generated code amount. When the generated code amount is not greater than the target generated code amount, the code amount control unit 40 proceeds to step ST14, and when the generated code amount is greater than the target generated code amount, proceeds to step ST15.

In step ST14, the code amount control unit 40 determines a basic quantizing parameter from the predicted quantizing parameter. When difference between the generated code amount and the target generated code amount is small, e.g., when the difference is smaller than the increase of the generated code amount at the time of reducing the value of the predicted quantizing parameter by one for example, the code amount control unit 40 takes the predicted quantizing parameter as a basic quantizing parameter, and ends the processing. Also, when difference between the generated code amount and the target generated code amount is great, the code amount control unit 40 reduces the value of the predicted quantizing parameter so as to reduce the difference, and takes this as a basic quantizing parameter.

In step ST15, the code amount control unit 40 increases the value of the predicted quantizing parameter. The code amount control unit 40 determines an increment according to the difference between the generated code amount and the target generated code amount, increases the value of the predicted quantizing parameter, and proceeds to step ST16.

In step ST16, the code amount control unit 40 calculates 1 GOP worth of generated code amount. The code amount control unit 40 uses the quantizing parameter updated in step ST115 to calculate 1 GOP worth of generated code amount in the same way as in step ST12, and proceeds to step ST17.

In step ST17, the code amount control unit 40 distinguishes whether or not the target generated code amount is realizable. In the event that distinction is made that the target generated code amount is unrealizable, the code amount control unit 40 returns to step ST13, and in the event that distinction is made that the target generated code amount is realizable, takes the quantizing parameter updated in step ST15 as a basic quantizing parameter, and ends the processing. For example, when a generated code amount at the time of employing the quantizing parameter updated in step ST15 is equal to or smaller than the target generated code amount, and a generated code amount at the time of employing a quantizing parameter smaller than the quantizing parameter updated in step ST15 by one exceeds the target generated code amount, the code amount control unit 40 distinguishes that the target generated code amount is realizable, and takes the updated quantizing parameter as a basic quantizing parameter.

Thus, a basic quantizing parameter can be determined whereby the target generated code amount can be realized. Note that the basic quantizing parameter determining processing is not restricted to the processing illustrated in the flowchart in FIG. 4. For example, the increment or decrement of a quantizing parameter is set according to the difference between the generated code amount and the target generated code amount to calculate a generated code amount again. Also, when the difference between the generated code amount and the target generated code amount is small, a quantizing parameter whereby the target generated code amount can be realized may be searched by increasing or decreasing the quantizing parameter by one at a time.

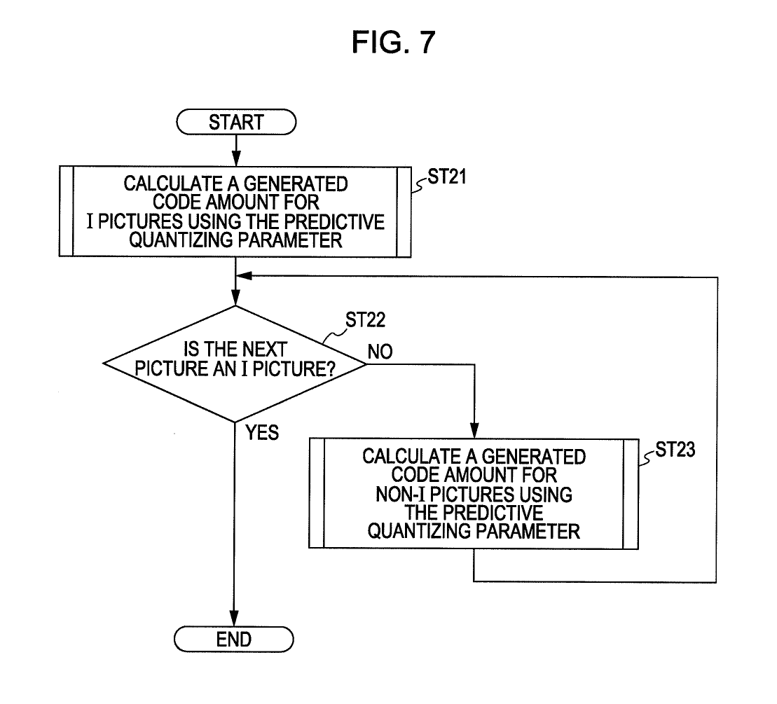

FIG. 7 is a flowchart exemplifying 1 GOP worth of generated code amount calculation processing. In step ST21, the code amount control unit 40 calculates the generated code amount of an I picture using the predicted quantizing parameter, and proceeds to step ST22.

In step ST22, the code amount control unit 40 distinguishes whether or not the next picture is an I picture. When the next picture is not an I picture, the code amount control unit 40 proceeds to step ST23, and when the next picture is an I picture, ends the 1 GOP worth of generated code amount calculation processing.

In step ST23, the code amount control unit 40 uses the predicted quantizing parameter to calculate the generated code amount of a non-I picture, i.e., a P picture or B picture, and returns to step ST22.

Next, description will be made regarding processing for predicting the generated code amount of an I picture, and the generated code amount of a non-I picture using the predicted quantizing parameter.

In the event of predicting the generated code amount of an I picture using the predicted quantizing parameter, the code amount control unit 40 predicts a generated code amount at the time of the predicted quantizing parameter being employed based on the generated code amount of the pre-encoding processing. This predicted generated code amount will be referred to as a first generated code amount. Also, the code amount control unit 40 calculates a generated code amount at the time of the predicted quantizing parameter being employed from the generated code amount obtained in the intra pre-encoding processing. This calculated generated code amount will be referred to as a second generated code amount. The code amount control unit 40 calculates a correction coefficient from the first generated code amount and the second generated code amount. Further, the code amount control unit 40 corrects the first generated code amount by the calculated correction coefficient, and takes the first generated code amount after correction as the generated code amount of an I picture at the time of the predicted quantizing parameter being employed. Also, the code amount control unit 40 calculates high-frequency component cost indicating the state of a high-frequency component in an I picture, and uses the calculated high-frequency component cost to perform correction of the first generated code amount.

In the event of predicting the generated code amount of a non-I picture using the predicted quantizing parameter, the code amount control unit 40 predicts a generated code amount at the time of the predicted quantizing parameter being employed based on the generated code amount of the pre-encoding processing. This predicted generated code amount will be referred to as a third generated code amount. Also, the code amount control unit 40 calculates a correction coefficient in a non-I picture, uses this correction coefficient to perform correction of the third generated code amount, and takes the third generated code amount after correction as the generated code amount of a non-I picture at the time of the predicted quantizing parameter being employed.

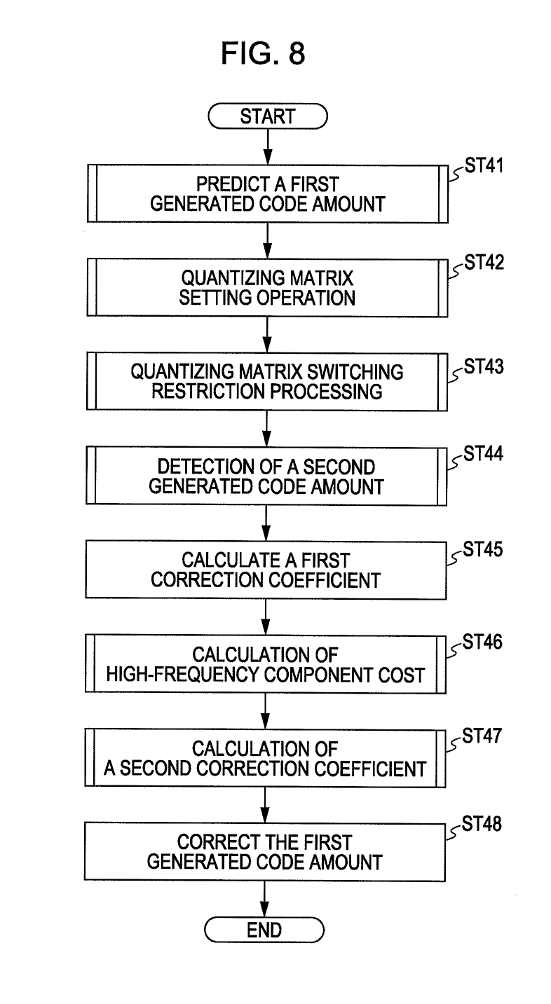

FIG. 8 is a flowchart illustrating generated code amount calculation processing for I pictures at the time of the predicted quantizing parameter being employed.

In step ST41, the code amount control unit 40 predicts the first generated code amount. The code amount control unit 40 predicts a generated code amount at the time of employing the predicted quantizing parameter, takes this as the first generated code amount, and proceeds to step ST42. For example, such as illustrated in FIG. 6, the code amount control unit 40 uses the selected predictive curve CB to predict a quantization parameter whereby the generated code amount has a value equal to or less than the target generated code amount BT(t) and most closely approximated thereto, and predicts a generated code amount at the time of employing this predicted quantizing parameter. That is to say, the code amount control unit 40 takes the generated code amount BT(pt) of the predicted quantizing parameter QP(t) as the first generated code amount, and proceeds to step ST42. Note that the quantizing parameter QP(p) should be set to a small value beforehand so that the generated code amount at the time of performing encoding using the quantizing parameter QP(p) becomes greater than the target generated code amount. In the event of thus setting the quantizing parameter QP(p), a basic quantizing parameter can be set so as to decrease the generated code amount equal to or smaller than the target generated code amount and most closely approximated thereto.

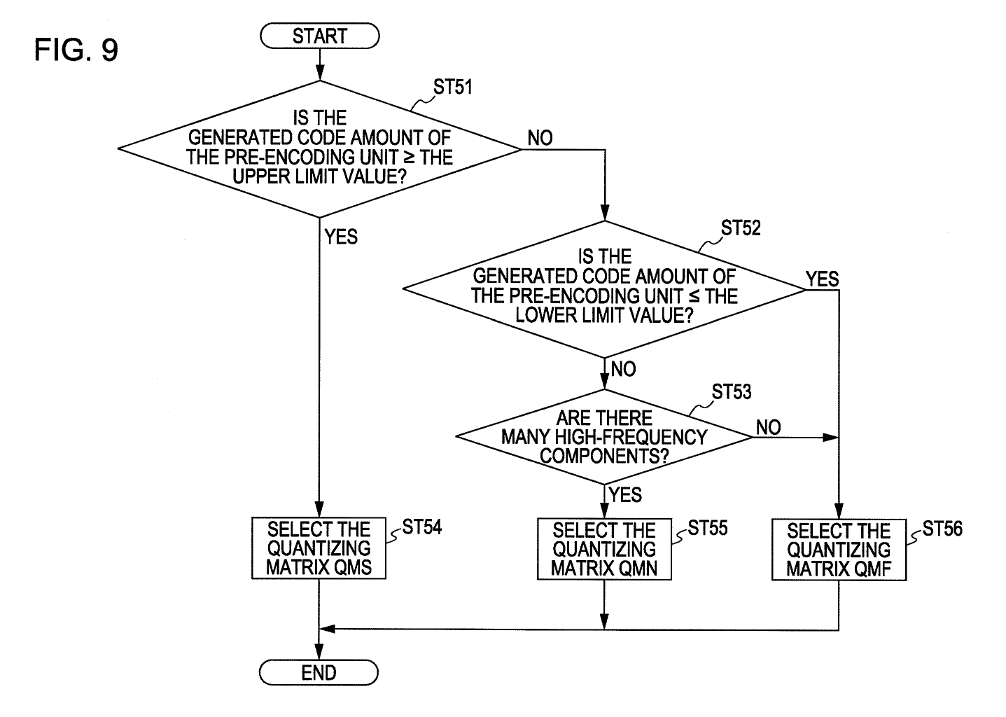

In step ST42, the code amount control unit 40 performs quantizing matrix selecting operation. FIG. 9 is a flowchart illustrating the quantizing matrix selecting operation. In step ST51, the code amount control unit 40 distinguishes whether or not the generated code amount of the pre-encoding unit 20 is equal to or greater than an upper limit value. When the generated code amount is smaller than the upper limit value, the code amount control unit 40 proceeds to step ST52, and when the generated code amount is equal to or greater than the upper limit value, proceeds to step ST54.

In step ST52, the code amount control unit 40 distinguishes whether or not the generated code amount of the pre-encoding unit 20 is equal to or less than a lower limit value. When the generated code amount is greater than the lower limit value, the code amount control unit 40 proceeds to step ST53, and when the generated code amount is equal to or less than the lower limit value, proceeds to step ST56.

In step ST53, the code amount control unit 40 distinguishes whether or not there are many high-frequency components. The code amount control unit 40 calculates an identification value that enables it identifiable from the generated code amount of the intra pre-encoding unit 30 whether or not there are many high-frequency components. The code amount control unit 40 calculates the percentage of the generated code amount at the time of employing the quantizing matrix QMN as to the generated code amount at the time of employing the quantizing matrix QMF, and sets this to the identification value. In the event of distinguishing that the calculated identification value is greater than a threshold THva, and there are many high-frequency components, the code amount control unit 40 proceeds to step ST55, and in the event of distinguishing that the number of high-frequency components is small, proceeds to step ST56.

In step ST54, the code amount control unit 40 selects the quantizing matrix QMS. Since the generated code of the pre-encoding unit 20 is equal to or greater than the upper limit value, the code amount control unit 40 selects the quantizing matrix QMS illustrated in FIG. 2C. When thus selecting the quantizing matrix QMS, the high-frequency components are greatly reduced, and the generated code amount is reduced.

In step ST55, the code amount control unit 40 selects the quantizing matrix QMN. Since the generated code of the pre-encoding unit 20 is included in a range between the upper limit value and the lower limit value, and the number of high-frequency components is determined to be small, and accordingly, the code amount control unit 40 selects the quantizing matrix QMN illustrated in FIG. 2B, which is commonly employed.

In step ST56, the code amount control unit 40 selects the quantizing matrix QMF. Even when the generated code of the pre-encoding unit 20 is equal to or less than the lower limit value, or included in a range between the upper limit value and the lower limit value, since the number of high-frequency components is determined to be small, and accordingly, the code amount control unit 40 selects the quantizing matrix QMF illustrated in FIG. 2A. When thus selecting the quantizing matrix QMF, low-frequency components or high-frequency components may be prevented from being reduced.

When distinguishing that the number of high-frequency components is great, the code amount control unit 40 selects the quantizing matrix QMN for reducing high-frequency components, and when distinguishing that the number of high-frequency components is small, selects the quantizing matrix QMF for reducing a smaller number of high-frequency components. Accordingly, for example, an image of which the high-frequency components have already been reduced by encoding and decoding processing is not subjected to encoding using the quantizing matrix for reducing high-frequency components, whereby image quality can be prevented from deteriorating. Also, when the generated code amount calculated at the pre-encoding unit 20 is equal to or greater than the upper limit value, the quantizing matrix QMS for reducing a greater number of high-frequency components than the quantizing matrix QMN is selected, whereby the quantizing matrix for reducing the generated code amount can be selected.

Note that with the quantizing matrix selecting operation illustrated in FIG. 9, selection of a quantizing matrix is performed according to a generated code amount, but selection of a quantizing matrix may be performed according to the value of the quantizing parameter QP(t) calculated in step ST41. For example, in step ST51, when the value of the quantizing parameter QP(t) is smaller than a first parameter value, in step ST54 the quantizing matrix QMS is selected. Also, in step ST51, when the parameter value of the quantizing parameter QP(t) is greater than a predetermined second value (a value greater than the first value), in step ST56 the quantizing matrix QMF may be selected.

When the quantizing matrix selecting operation ends in step ST42, the code amount control unit 40 proceeds to step ST43.

In step ST43, the code amount control unit 40 performs quantizing matrix switching restriction processing. The code amount control unit 40 performs the quantizing matrix switching restriction processing so as to prevent image quality from becoming unstable, for example, by a different quantizing matrix being selected as to similar images within a GOP, and switching of quantizing matrices being frequently performed.

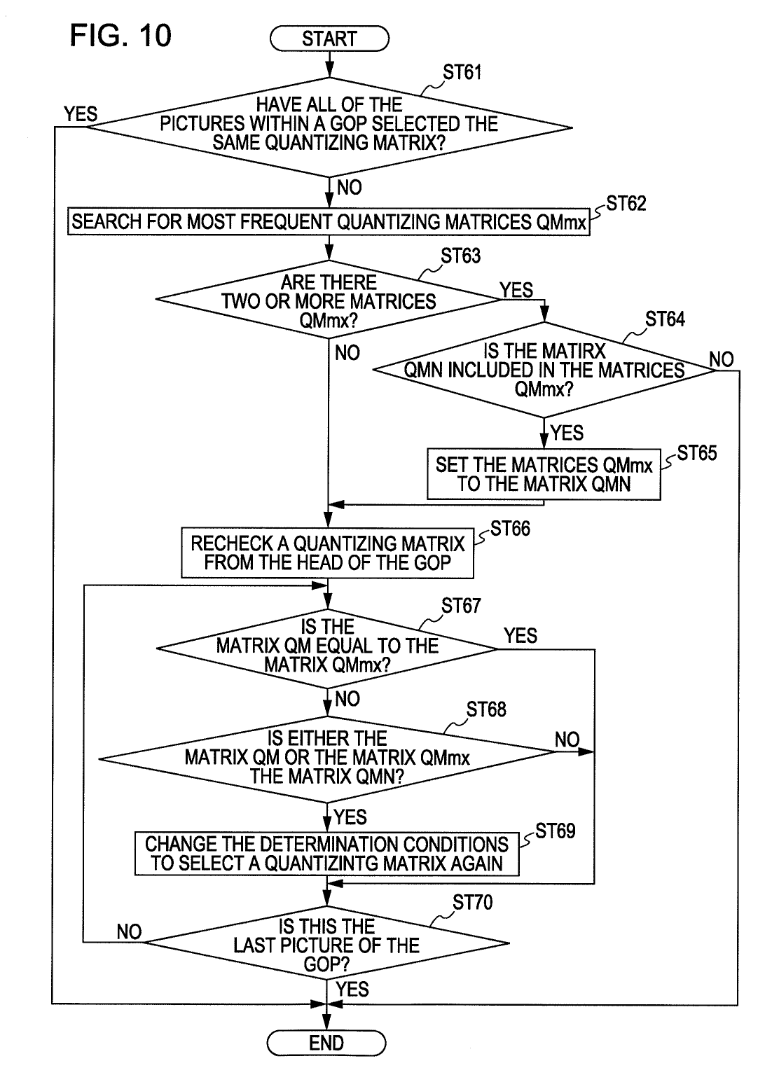

FIG. 10 is a flowchart illustrating the quantizing matrix switching restriction processing. In step ST61, the code amount control unit 40 distinguishes whether or not all the pictures within a GOP have selected the same quantizing matrix. When all the pictures within a GOP do not select the same quantizing matrix, the code amount control unit 40 proceeds to step ST62. Also, when all the pictures within a GOP select the same quantizing matrix, the code amount control unit 40 ends the switching restriction processing.

In step ST62, the code amount control unit 40 searches for a most frequent quantizing matrix to be most frequently employed. The code amount control unit 40 takes a quantizing matrix to be most frequently employed within a GOP as a most frequent quantizing matrix QMmx, and proceeds to step ST63.

In step ST63, the code amount control unit 40 distinguishes whether or not there are two or more most frequent quantizing matrices QMmx. When there are two or more most frequent quantizing matrices QMmx, the code amount control unit 40 proceeds to step ST64, and when there is a single most frequent quantizing matrix QMmx, proceeds to step ST66.

In step ST64, the code amount control unit 40 distinguishes whether or not the quantizing matrix QMN is included in the most frequent quantizing matrices QMmx. When the quantizing matrix QMN is included in the most frequent quantizing matrices QMmx, the code amount control unit 40 proceeds to step ST65. Also, when the quantizing matrix QMN is not included in the most frequent quantizing matrices QMmx, i.e., in the event that the quantizing matrix QMF and the quantizing matrix QMS have been selected as the most frequent quantizing matrices QMmx, the code amount control unit 40 ends the stabilization control operation. In the event that the quantizing matrix QMF and the quantizing matrix QMS have been selected as the most frequent quantizing matrices QMmx, with a picture selecting the quantizing matrix QMF and a picture selecting the quantizing matrix QMS, estimation is made wherein the generated code amounts completely differ, and the images do not resemble each other. Accordingly, the stabilization control operation ends.

In step ST65, the code amount control unit 40 sets the quantizing matrix QMN to the most frequent quantizing matrices QMmx, and proceeds to step ST66.

In step ST66, the code amount control unit 40 performs recheck of the quantizing matrix from the head of the GOP, and proceeds to step ST67.

In step ST67, the code amount control unit 40a distinguishes whether or not the quantizing matrix QM is equal to the most frequent quantizing matrix QMmx. When the quantizing matrix QM of the picture is not equal to the most frequent quantizing matrix QMmx, the code amount control unit 40 proceeds step ST68, and when both are equal, proceeds to step ST70.

In step ST68, the code amount control unit 40 distinguishes whether or not either the quantizing matrix QM or the most frequent quantizing matrix QMmx is the quantizing matrix QMN. When either the quantizing matrix QM or the most frequent quantizing matrix QMmx is the quantizing matrix QMN, the code amount control unit 40 proceeds to step ST69. Also, when neither is the quantizing matrix QMN, the code amount control unit 40 proceeds to step ST70. That is to say, when one of the quantizing matrix QM and the most frequent quantizing matrix QMmx is the quantizing matrix QMF, and the other is the quantizing matrix QMS, as described above, the images are estimated to not resemble each other, and accordingly, the code amount control unit 40 proceeds to step ST70.

In step ST69, the code amount control unit 40 changes the determination conditions to perform reselection of the quantizing matrix. The code amount control unit 40 changes the upper limit value employed in step ST51 in FIG. 9 or the threshold THva employed in step ST53 to a value where the most frequent quantizing matrix is selected in a picture having an image resembling a picture at the time of the most frequent quantizing matrix being selected. Further, the code amount control unit 40 uses the upper limit value or threshold THva after change to perform selection of a quantizing matrix again, and proceeds to step ST70. The code amount control unit 40 performs, for example, addition/subtraction of the upper limit value or threshold THva using a predetermined correction value, thereby changing the upper limit value or threshold THva.

In step ST70, the code amount control unit 40 distinguishes whether or not the present picture is the final picture of the GOP. When the present picture is not the final picture, the code amount control unit 40 returns to step ST67, and at the time of the final picture of the GOP, ends the switching restriction processing.

In the event of thus performing the quantizing matrix switching restriction processing, with similar images within a GOP, the same quantizing matrix is selected, and accordingly, switching of quantizing matrices is reduced, and image quality can be stabilized.

In step ST44, the code amount control unit 40 performs calculation of a second generated code amount. The code amount control unit 40 detects the generated code amount BT(it) in the quantizing parameter QP(t) from the generated code amounts calculated at the intra pre-encoding unit 30, and takes this as a second generated code amount. Here, in the case that the quantizing matrix QMN is employed at the pre-encoding unit 20, the code amount control unit 40 detects the generated code amount BT(it) in the quantizing parameter QP(t) from the generated code amounts BT(i0N), BT(i1N), and BT(i2N) at the time of performing encoding using the quantizing parameters QP(i0) through QP(i2), and the quantizing matrix QMN, and takes this as the second generated code amount.

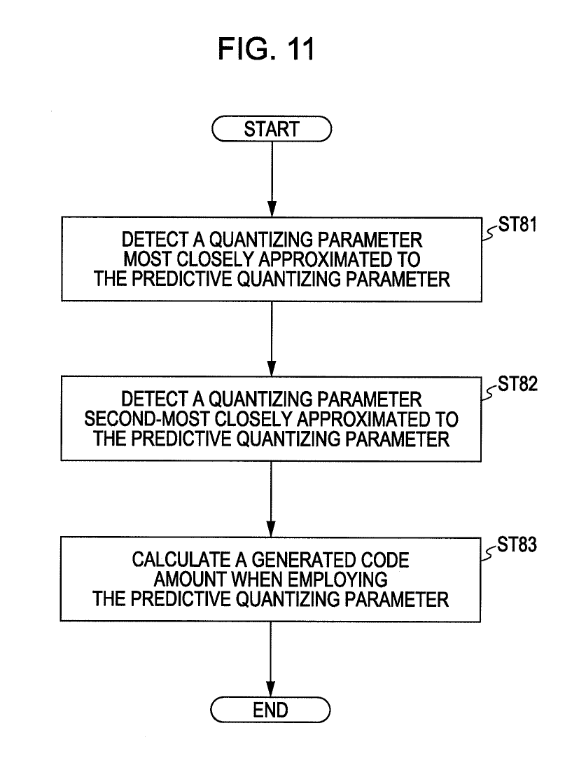

FIG. 11 is a flowchart illustrating second generated code amount detection processing. In step ST81, the code amount control unit 40 detects a quantizing parameter most closely approximated to the predicted quantizing parameter from quantizing parameters employed in the intra pre-encoding processing. The code amount control unit 40 detects a quantizing parameter most closely approximated to the quantizing parameter QP(t) out of the quantizing parameters QP(i0) through QP(i2) for example, takes this as a quantizing parameter QP(ia), and proceeds to step ST82.

In step ST82, the code amount control unit 40 detects a quantizing parameter second-most closely approximated to the predicted quantizing parameter out of the quantizing parameters employed in the intra pre-encoding processing. The code amount control unit 40 detects a quantizing parameter second-most closely approximated to the quantizing parameter QP(t) out of the quantizing parameters QP(i0) through QP(i2) for example, takes this as a quantizing parameter QP(ib), and proceeds to step ST83.

In step ST83, the code amount control unit 40 calculates a generated code amount at the time of employing the predicted quantizing parameter. The code amount control unit 40 uses the generated code amount BT(iaN) at the time of employing the quantizing parameter QP(ia) and the quantizing matrix QMN, and the generated code amount BT(ibN) at the time of employing the quantizing parameter QP(ib) and the quantizing matrix QMN to perform interpolation processing. The code amount control unit 40 performs linear interpolation, curve interpolation, or the like as the interpolation processing to calculate the generated code amount BT(it) of the predicted quantizing parameter QP(t).

The code amount control unit 40 thus calculates the second generated code amount BT(it), and proceeds from step ST44 to step ST45 in FIG. 8.

In step ST45, the code amount control unit 40 calculates a first correction coefficient. The code amount control unit 40 uses the first generated code amount BT(pt) detected from the pre-encoding processing results, and the second generated code amount BT(it) detected from the intra pre-encoding processing results to perform the calculation of Expression (1) to calculate a first correction coefficient C(i), and proceeds to step ST46.

C(i)=BT(it)/BT(pt) (1)

In step ST46, the code amount control unit 40 calculates high-frequency component cost. The code amount control unit 40 calculates high-frequency component cost H(i) indicating the state of a high-frequency component in an I picture.

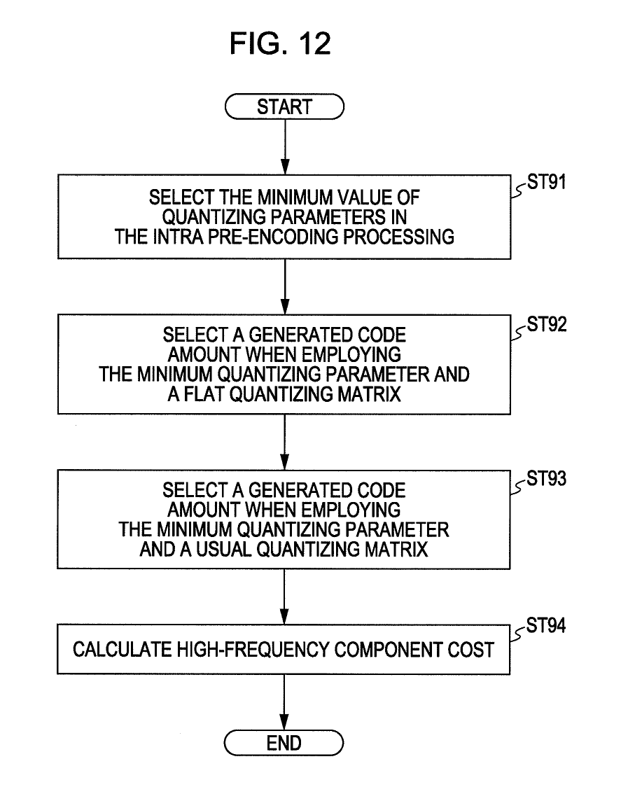

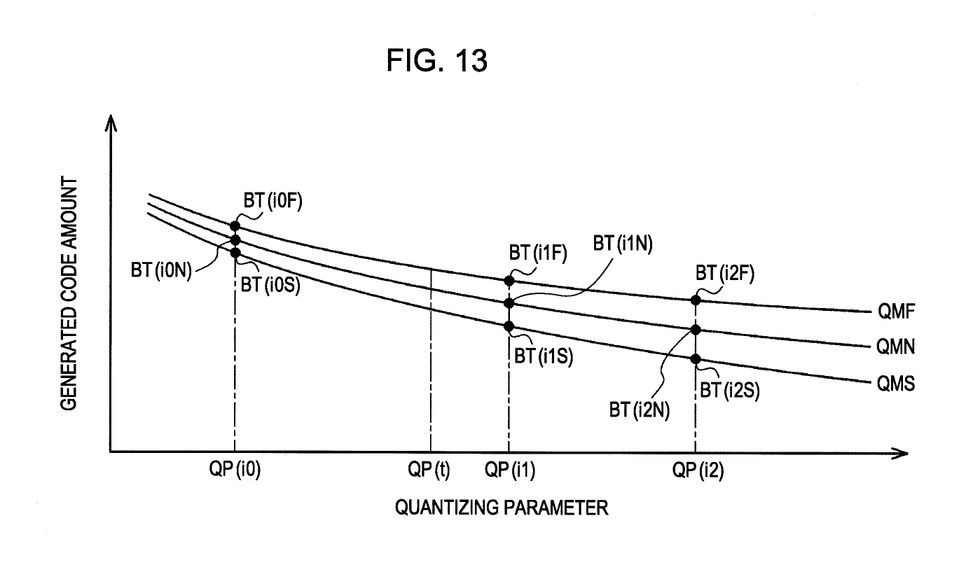

FIG. 12 is a flowchart illustrating high-frequency component cost calculating operation. Also, FIG. 13 illustrates output from the intra pre-encoding unit.

In FIG. 12, in step ST91 the code amount control unit 40 selects the minimum value of the quantizing parameters in the intra pre-encoding processing. For example, such as illustrated in FIG. 13, with the intra pre-encoding processing, in the event that quantizing parameters QP(i0), QP(i1), and QP(i2) (QP(i0)<QP(i1)<QP(i2)) are employed, the code amount control unit 40 selects the quantizing parameter QP(i0), and proceeds to step ST92.

In step ST92, the code amount control unit 40 selects a generated code amount when employing the smallest quantizing parameter, and a quantizing matrix of which the quantizing steps from a high frequency to a low frequency are flat. For example, the quantizing matrix QMF will be a matrix of which the matrix values are fixed values, and the quantizing steps from a high frequency to a low frequency are flat. The quantizing matrix QMN will be a matrix wherein the matrix value of a high frequency is a value greater than that of a low frequency, and a high frequency is roughly quantized as compared to a low frequency. The quantizing matrix QMS will be a matrix wherein the matrix value of a high frequency is a further great value as compared to the quantizing matrix QMN, and quantization is performed in a state in which the attenuation of a high frequency is steep as compared to the quantizing matrix QMN. In this case, as the quantizing parameter QP(i0) is selected as the smallest quantizing parameter, the code amount control unit 40 selects the generated code amount BT(i0F) at the time of employing the quantizing parameter QP(i0) and the quantizing matrix QMF, and proceeds to the step ST93.

In step ST93, the code amount control unit 40 selects a generated code amount at the time of employing the smallest quantizing parameter, and a common quantizing matrix for roughly quantizing a high frequency as compared to a low frequency. For example, the code amount control unit 40 selects the generated code amount BT(i0N) at the time of employing the quantizing parameter QP(i0) and the quantizing matrix QMN, and proceeds to step ST94.

In step ST94, the code amount control unit 40 calculates high-frequency component cost. The code amount control unit 40 performs the calculation of Expression (2) to calculate high-frequency component cost H(i).

H(i)=BT(i0F)/BT(i0N) (2)

When thus calculating high-frequency cost in step ST46 in FIG. 8, the code amount control unit 40 proceeds to step ST47, and performs the calculation of a second correction coefficient. The second correction coefficient is a correction coefficient for correcting the predicted generated code amount to a generated code amount at the time of employing the quantizing matrix used at the main encoding unit 60. Note that the quantizing matrix used at the main encoding unit 60 is a quantizing matrix selected for each picture in steps ST42 and ST43, and will be taken as a quantizing matrix QMW in the following description.

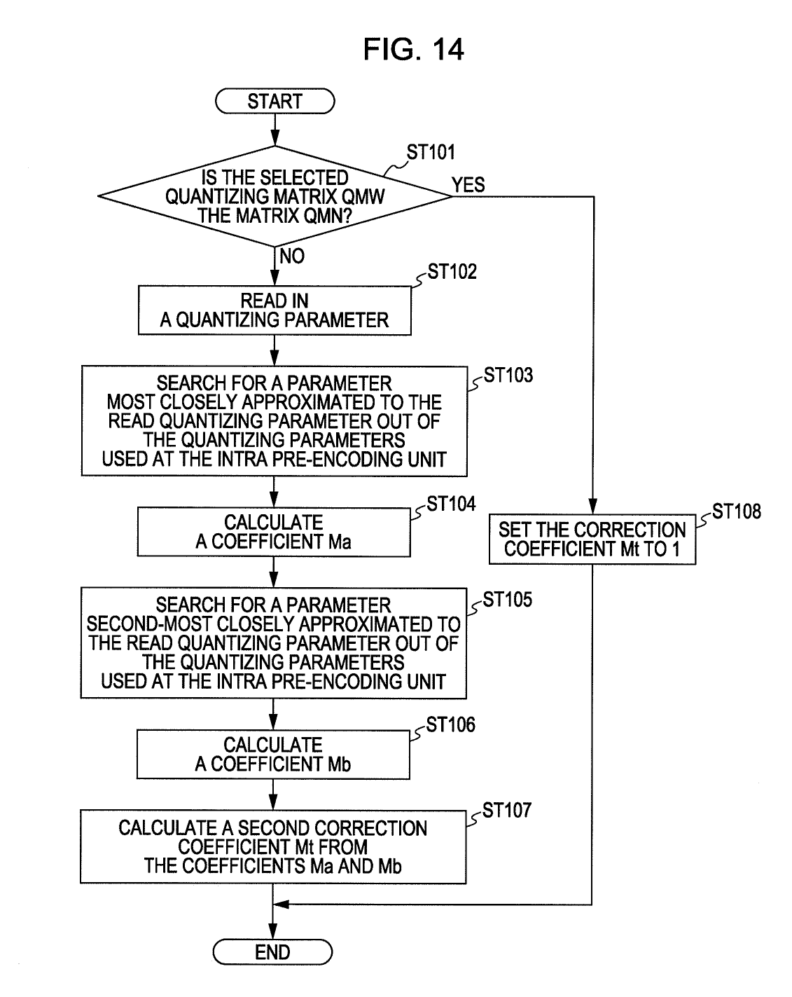

FIG. 14 is a flowchart illustrating second correction coefficient calculating operation. In step ST101, the code amount control unit 40 distinguishes whether or not the selected matrix QMW is the quantizing matrix QMN. When the selected quantizing matrix QMW is not the quantizing matrix QMN, the code amount control unit 40 proceeds to step ST102, and when the selected quantizing matrix QMW is the quantizing matrix QMN, proceeds to step ST108.

In step ST102, the code amount control unit 40 performs reading of the quantizing parameter. The code amount control unit 40 reads in the quantizing parameter QP(t) predicted in step ST41, and proceeds to step ST103.

In step ST103, the code amount control unit 40 selects a quantizing parameter most closely approximated to the quantizing parameter used at the intra pre-encoding unit 30. The code amount control unit 40 selects, for example, a parameter most closely approximated to the quantizing parameter QP(t) out of the quantizing parameters QP(i0) through QP(i2), takes this as a quantizing parameter QP(ia), and proceeds to step ST104.

In step ST104, the code amount control unit 40 calculates a coefficient Ma in the quantizing parameter QP(ia). The code amount control unit 40 takes a generated code amount at the time of employing the quantizing matrix QMN in the quantizing parameter QP(ia) as BT(iaN). Also, with the quantizing parameter QP(ia), a generated code amount at the time of employing the quantizing parameter QMM selected in the quantizing matrix selecting operation is taken as BT(iaM). The code amount control unit 40 uses Expression (3) to calculate the coefficient Ma, and proceeds to step ST105.

Ma=BT(iaN)/BT(iaM) (3)

In step ST105, the code amount control unit 40 selects a quantizing parameter second-most closely approximated to the quantizing parameter used at the intra pre-encoding unit 30. The code amount control unit 40 selects, for example, a parameter second-most closely approximated to the quantizing parameter QP(t) out of the quantizing parameters QP(i0) through QP(i2), takes this as a quantizing parameter QP(ib), and proceeds to step ST106.

In step ST106, the code amount control unit 40 calculates a coefficient Mb in the quantizing parameter QP(ib). The code amount control unit 40 will take a generated code amount at the time of employing the quantizing matrix QMN in the quantizing parameter QP(ib) as BT(ibN). Also, with the quantizing parameter QP(ib), a generated code amount at the time of employing the quantizing parameter QMM selected in the quantizing matrix selecting operation will be taken as BT(ibM). The code amount control unit 40 uses Expression (4) to calculate the coefficient Mb, and proceeds to step ST107.

Mb=BT(ibN)/BT(ibM) (4)

In step ST107, the code amount control unit 40 calculates a second correction coefficient. Mt as to the quantizing parameter QP(t). The code amount control unit 40 performs interpolation processing, e.g., linear interpolation shown in Expression (5) using the coefficient Ma and the coefficient Mb to calculate the second correction coefficient Mt.

Mt=Ma+(Mb−Ma)×(QP(t)−QP(ia))/(QP(ib)−QP(ia)) (5)

In step ST108, the code amount control unit 40 will take the second correction coefficient Mt as “1”. As the quantizing matrix used at the pre-encoding unit 20, and the quantizing matrix used at the main encoding unit 60 are both the quantizing matrices QMN, the code amount control unit 40 will take the second correction coefficient Mt as “1”, and ends the processing.

In the event of calculating the second correction coefficient in this way, for example, such as illustrated in FIG. 13, a parameter most closely approximated to the quantizing parameter QP(t) is the quantizing parameter QP(i1), and a parameter second-most closely approximated to the quantizing parameter QP(t) is the quantizing parameter QP(i0), and in the event that the quantizing matrix QMS has been selected, the second correction coefficient Mt can be calculated by performing the calculation of Expressions (3) through (5) with BT(iaN)=BT(i1N), BT(iaM)=BT(i1S), BT(ibN)=BT(i0N), BT(ibN)=BT(i0N), BT(ibM)=BT(i0S), QP(ia)=QP(i1), and QP(ib)=QP(i0).

In this way, after calculating the second coefficient in step ST47 in FIG. 8, the code amount control unit 40 proceeds to step ST48, and performs correction of the first generated code amount. The code amount control unit 40 performs the calculation of Expression (6) using the generated code amount BT(pt) and the correction coefficient C(i) to calculate a corrected generated code amount BT(itc).

BT(itc)=BT(pt)×C(i)×Mt (6)

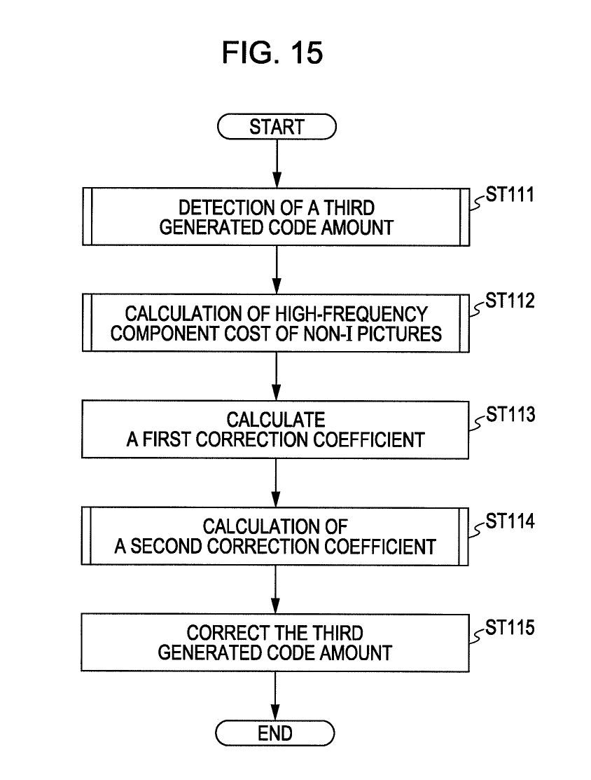

Next, description will be made regarding non-I picture generated code amount calculating processing at the time of employing the predicted quantizing parameter using the flowchart illustrated in FIG. 15. In step ST111, the code amount control unit 40 performs detection of a third generated code amount. The code amount control unit 40 classifies macro blocks into groups according to the generated code amount BT(p) at the time of performing encoding using the fixed quantizing parameter QP(p) at the pre-encoding unit 20. Also, the code amount control unit 40 selects a predictive curve of the corresponding group from multiple predictive curves indicating relationship between a quantizing parameter and a generated code amount provided for each group beforehand. Further, the code amount control unit 40 takes already predicted generated code amount BT(ut) in the quantizing parameter QP(t) using the selected predictive curve as the third generated code amount, and proceeds to step ST112.

In step ST112, the code amount control unit 40 calculates high-frequency component cost in a non-I picture. The code amount control unit 40 performs the same processing as the high-frequency component cost calculation shown in the above FIG. 12 to calculate high-frequency cost H(u) in a non-I picture. In this case, calculation of the high-frequency component H(u) is performed using Expression (7).

H(u)=BT(i0F)/BT(i0N) (7)

Note that, in Expression (7), the generated code amounts BT(i0F) and BT(i0N) are generated code amounts at the time of subjecting the image data of a non-I picture for calculating high-frequency component cost to the intra pre-encoding processing as an I picture.

In this way, after calculating high-frequency cost in step ST112, the code amount control unit 40 proceeds to step ST113 to calculate a first correction coefficient. The code amount control unit 40 performs the calculation of Expression (8) using the correction coefficient C(i) and the high-frequency component cost H(i) calculated in the I picture, and the high-frequency component cost H(u) calculated in step ST112 to calculate a correction coefficient C(ic), and proceeds to step ST114.

C(ic)=C(i)×H(i)/H(u) (8)

In step ST114, the code amount control unit 40 performs second correction coefficient calculating operation. The code amount control unit 40 performs the second correction coefficient calculating operation described with reference to FIG. 14 to calculate a second correction coefficient Mtu corresponding to a non-I picture from the generated code amount calculated in an I picture of the intra pre-encoding unit 30 corresponding to a non-I picture, and proceeds to step ST115.

In step ST115, the code amount control unit 40 performs correction of a third generated code amount. The code amount control unit 40 performs the calculation of Expression (9) using the correction coefficients C(ic) and Mtu to correct the generated code amount BT(utc) serving as a third generated code amount, thereby calculating a corrected generated code amount BT(utc). Note that the correction coefficient Mtu is a correction coefficient calculated in the same way as with an I picture using the generated code amount of a non-I picture.

BT(utc)=BT(ut)×C(ic)×Mtu (9)

In this way, the code amount control unit 40 performs correction of the generated code amount of a non-I picture. Further, the code amount control unit 40 determines a quantizing parameter wherein the total of generated code amounts after correction of 1 GOP is equal to or smaller than the target generated code amount and most closely approximated to the target generated code amount. The main encoding unit 60 performs encoding of the image data using the quantizing parameter and the quantizing matrix determined at the code amount control unit 40, and outputs the encoded data.

As describe above, a quantizing matrix is selected from multiple different quantizing matrices based on the high-frequency component distinction results using the generated code amount calculated at the pre-encoding unit 20, and the generated code amount calculated at the intra pre-encoding unit 30, and accordingly, deterioration in image quality can be reduced. For example, from the results obtained at the intra pre-encoding unit 30, when the percentage of a generated code amount at the time of employing the quantizing matrix QMN as to the generated code amount at the time of employing the quantizing matrix QMF is great, the number of high-frequency components is also great. That is to say, the present image may be a raw image with a high possibility. Also, when the percentage of a generated code amount at the time of employing the quantizing matrix QMN as to the generated code amount at the time of employing the quantizing matrix QMF is small, the number of high-frequency components is also small. That is to say, the present image may be a dubbing image or the like from which the high-frequency components have been reduced, with a high possibility. Accordingly, when the number of high-frequency components is small, deterioration in image quality can be reduced by selecting a quantizing matrix for reducing a smaller number of high-frequency components. Also, when the generated code amount calculated at the pre-encoding unit 20 is greater than the upper limit value, a quantizing matrix for reducing a further greater number of high-frequency components should be selected, and when the generated code amount is smaller than the lower limit value, a quantizing matrix for reducing neither lower-frequency components nor high-frequency components should be selected. Thus, deterioration in image quality can further be reduced as compared a case where the target generated code amount is realized with a quantizing parameter alone.

Also, with the code amount control unit 40, a quantizing parameter for realizing the target generated code amount based on the generated code amount calculated by performing pre-encoding at the pre-encoding unit 20, and a generated code amount at the time of employing this quantizing parameter, are predicted. Also, the predicted generated code amount is corrected according to the generated code amount calculated by performing pre-encoding at the intra pre-encoding unit 30. Further, with the code amount control unit 40, a quantizing parameter is determined so that the generated code amount after correction realizes the target generated code amount. Therefore, for example, in the case that relationship between the generated code amount and quantizing parameter of a macro block is changed according to images, the prediction error of the generated code amount caused due to this change is corrected according to the generated code amount calculated by performing pre-encoding at the intra pre-encoding unit 30. Accordingly, even when relationship between the generated code amount and quantizing parameter of a macro block is changed according to images, prediction of a generated code amount can accurately be performed.

For example, prediction of a generated code amount is performed by performing the pre-encoding processing, and the quantizing parameter of the main encoding is determined from the prediction results. In this case, as a cause where error occurs with prediction, when the number of high-frequency components is smaller than estimation, the falling way of the generated code amount is changed, and accordingly, the actual generated code amount may significantly be smaller than prediction. In particular, when difference between the quantizing parameter (p) fixed in the pre-encoding processing, and the quantizing parameter QP(t) corresponding to the target generated code amount is great, error is also apt to increase.

In order to correct this error, the code amount control unit 40 takes advantage of the generated code amount obtained by the intra pre-encoding proceeding for I pictures. The intra pre-encoding unit 30 applies multiple quantizing parameters, and accordingly, the generated code amount of a quantizing parameter more closely approximated to the predicted quantizing parameter than the pre-encoding unit 20 can be obtained. Therefore, with prediction of an I picture, the predicted generated code amount is corrected according to the generated code amount calculated at the intra pre-encoding unit 30.

Also, error is not allowed to be obtained regarding non-I pictures. However, this error fluctuates according to the state of a high-frequency component within a picture, and accordingly, the state of a high-frequency component is obtained from each picture, and the generated code amount of a non-I picture is corrected according to difference between the state of a high-frequency component in each picture and the state of a high-frequency component in an I picture.

Thus, even when the state of a high-frequency component differs from that at the time of obtaining a predictive curve, a generated code amount can be corrected according to the state of a high-frequency component of a picture, the generated code can be predicted in a more accurate manner. Accordingly, for example, prediction of 1 GOP worth of generated code amount can accurately be performed.

Further, in the event that a generated code amount has been obtained by applying the quantizing matrix QMN at the pre-encoding unit 20, when a different quantizing matrix is selected, prediction may deviate. In this case, a correction coefficient is calculated from the generated code amount calculated at the intra pre-encoding unit 30, the generated code amount obtained by using the quantizing matrix used at the pre-encoding unit 20, and the generated code amount obtained by using the selected quantizing matrix. Accordingly, even when a quantizing matrix different from the quantizing matrix used at the pre-encoding unit 20 is selected, for example, prediction of 1 GOP worth of generated code amount can accurately be performed.

Therefore, in the event of performing encoding using the basic quantizing parameter and quantizing matrix determined at the code amount control unit 40, the main encoding unit 60 can output encoded data with little deterioration in an image from the main encoding unit 60 even when the generated code amount is equal to or less than the target generated code amount.

Further, when the quantizing matrix of each picture within a GOP differs, a quantizing matrix used by pictures of which the number is the most numerous is searched, with a setting condition whereby this quantizing matrix used by pictures of which the number is the most numerous is readily set, resetting of a quantizing matrix is performed regarding a picture within the GOP. Accordingly, with similar images, switching of quantizing matrices can be prevented from being frequently performed, and accordingly, the image quality of an encoded image can be stabilized.

Also, a series of processing described in the present Specification may be executed by hardware, software, or a combined configuration of both. In the case of executing processing by software, a program in which processing sequence is recorded may be executed by being installed in memory within a computer housed in dedicated hardware, or may be executed by being installed in a general-purpose computer capable of executing various types of processing.

For example, the program may be recorded beforehand in a hard disk or ROM (Read Only Memory) serving as a recording medium, or may be temporarily or eternally stored (recorded) in a removable medium such as a flexible disk, CD-ROM (Compact Disc Read Only Memory), MO (Magneto Optical) disk, DVD (Digital Versatile Disc), a magnetic disk, semiconductor memory, or the like. Such a removable medium may be provided as so-called packaged software.

Note that the program may be transferred from a download site to a computer wirelessly, or by cable via a network such as a LAN (Local Area Network), the Internet, or the like in addition to being installed in a computer from a removable recording medium such as described above. The computer can receive the program thus transferred so as to be installed in a recording medium such as a built-in hard disk or the like.

The present application contains subject matter related to that disclosed in Japanese Priority Patent Application JP 2009-173910 filed in the Japan Patent Office on Jul. 27, 2009, the entire content of which is hereby incorporated by reference.

Note that the present invention is not be interpreted in a manner restricted to the above embodiments of the invention. With the embodiments of the present invention, the present invention has been disclosed in an exemplification mode, and it is apparent that one skilled in the art can conceive various modifications or alternations without departing from the essence and spirit of the present invention. That is to say, in order to understand the essence and spirit of the present invention, the Claims should be referred to.

What is claimed is:

1. An image encoding device comprising:
a first encoding unit configured to perform encoding of image data using a plurality of different quantizing matrices to calculate a generated code amount for each of said quantizing matrices;
a code amount control unit configured to calculate an identification value that makes it identifiable from the generated code amount calculated at said first encoding unit whether or not there are many high-frequency components, and to select a first quantizing matrix for reducing high-frequency components at the time of this identification value distinguishing that the number of high-frequency components is greater than a threshold, and to select a second quantizing matrix that reduces a smaller number of high-frequency components than said first quantizing matrix at the time of the identification value distinguishing that the number of high-frequency components is not greater than the threshold and small; and
a second encoding unit configured to perform encoding of said image data using the quantizing matrix selected at said code amount control unit.

2. The image encoding device according to claim 1, further comprising:
a third encoding unit configured to perform encoding of image data using a fixed quantizing parameter and a fixed quantizing matrix to calculate a generated code amount;
wherein said code amount control unit selects a third quantizing matrix that reduces a greater number of high-frequency components than said first quantizing matrix at the time of the generated code amount calculated at said third encoding unit being equal to or greater than an upper limit value.

3. The image encoding device according to claim 2, wherein said code amount control unit performs selection of a quantizing matrix for each picture within a GOP (Group of Pictures), and when the quantizing matrices differ within the GOP, searches for a quantizing matrix used by pictures of which the number is the most numerous, and said threshold and said upper limit value are changed to a value whereby said most frequent quantizing matrix is selected of a picture of which the image resembles that of a picture at the time of said most frequent quantizing matrix being selected, to perform selection of a quantizing matrix again.

4. The image encoding device according to claim 1, further comprising:
a third encoding unit configured to perform encoding of image data using a fixed quantizing parameter and a fixed quantizing matrix to calculate a generated code amount;
wherein said first encoding unit performs calculation of said generated code amount using a plurality of different quantizing parameters;
and wherein said code amount control unit performs prediction of a generated code amount at the time of using a quantizing parameter for realizing a target generated code amount, and a generated code amount at the time of using this quantizing parameter based on the generated code amount calculated at said third encoding unit, corrects this predicted generated code amount according to the generated code amount calculated at said first encoding unit, and determines a quantizing parameter so that the generated code amount after correction realizes said target generated code amount;
and wherein said second encoding unit performs encoding of said image data using the quantizing parameter determined at said code amount control unit.

5. The image encoding device according to claim 4, wherein said first encoding unit performs said generated code amount calculation using a quantizing matrix used at said third encoding unit, and a quantizing matrix different from that quantizing matrix as said plurality of different quantizing matrices;
and wherein said code amount control unit performs selection of a quantizing matrix from the plurality of different quantizing matrices used at said first encoding unit, and when this selected quantizing matrix differs from the quantizing matrix used at said third encoding unit, calculates a correction coefficient from the generated code amount calculated at said first encoding unit, and corrects said predicted generated code amount using said correction coefficient.

6. The image encoding device according to claim 5, wherein said code amount control unit sets a coefficient indicating the percentage of a generated code amount at the time of using said selected quantizing matrix as to a generated code amount at the time of using the fixed quantizing matrix used at said third encoding unit, to said correction coefficient.

7. The image encoding device according to claim 6, wherein said code amount control unit performs interpolation processing using said coefficient of a quantizing parameter most closely approximated to said predicted quantizing parameter, and said coefficient of a quantizing parameter second-most closely approximated to said predicted quantizing parameter to calculate said correction coefficient of said predicted quantizing parameter.

8. An image encoding method comprising the steps of:
first encoding, performed by a first encoding unit, of image data using a plurality of different quantizing matrices to calculate a generated code amount for each of said quantizing matrices;
calculating, with a code amount control unit, of an identification value that makes it identifiable from the generated code amount calculated at said first encoding unit whether or not there are many high-frequency components, selecting a first quantizing matrix for reducing high-frequency components at the time of this identification value distinguishing that the number of high-frequency components is greater than a threshold, and selecting a second quantizing matrix that reduces a smaller number of high-frequency components than said first quantizing matrix at the time of the identification value distinguishing that the number of high-frequency components is not greater than the threshold and small; and
second encoding, performed by a second encoding unit, of said image data using the quantizing matrix selected at said code amount control unit.
